(19) United States
(12) Patent Application Publication
(10) Pub. No.: US 2012/0257062 A1
(43) Pub. Date: Oct. 11, 2012

(54) VIDEO SWITCH SYSTEM AND METHOD OF VIEWING SURVEILLANCE VIDEOS

(75) Inventors: Chi-Chih Wang, Tu Cheng (TW); Chien-Ming Chang, Tu Cheng (TW); Chun-Sheng Wang, Tu Cheng (TW)

(73) Assignee: HON HAI PRECISION INDUSTRY CO., LTD., New Taipei (TW)

(21) Appl. No.: 13/349,562

(22) Filed: Jan. 13, 2012

(30) Foreign Application Priority Data
Apr. 6, 2011 (CN) 201110084788.5

(51) Int. Cl. H04N 7/18

(52) U.S. Cl. 348/159; 348/E07.085

(57) ABSTRACT

In a video switch method of viewing surveillance videos implemented by a server, a dividing mode, an arrangement mode, and a switch mode are acquired from a client device when a user of the client device is validated. The server controls at least one agent-computing device to divide display screens of each monitors connected to the at least one agent-computing device, into several sub-display areas according to the dividing mode. Individual surveillance videos of different monitored places from video record devices are displayed on the sub-display areas created, according to the arrangement mode. A predetermined next surveillance video replaces a current surveillance video displayed on a sub-display, either by manual switching or by means of an automatic cycle over a period of time.

### BACKGROUND

1. Technical Field

Embodiments of the present disclosure relate to the field of video surveillance, and more particularly, to a video switch system and method of viewing surveillance videos.

2. Description of Related Art

Users prefer the lowest number of monitors possible when viewing surveillance videos of monitored places. Therefore, users may control the switching of scenes within the surveillance videos on the monitors via one or more matrix switch devices. However, the hardware cost of the matrix switch devices is very high. In addition, there is very little standardization between vendors of the matrix switch devices thus the users may have to purchase duplicate or superfluous devices.

### BRIEF DESCRIPTION OF THE DRAWINGS

FIG. 1 is a block diagram of one embodiment of a server including a video switch system.

FIG. 2 is a block diagram of one embodiment of functional modules of the video switch system included in the server of FIG. 1.

FIG. 3 is a flowchart of one embodiment of a video switch method of viewing surveillance videos implemented by the server of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

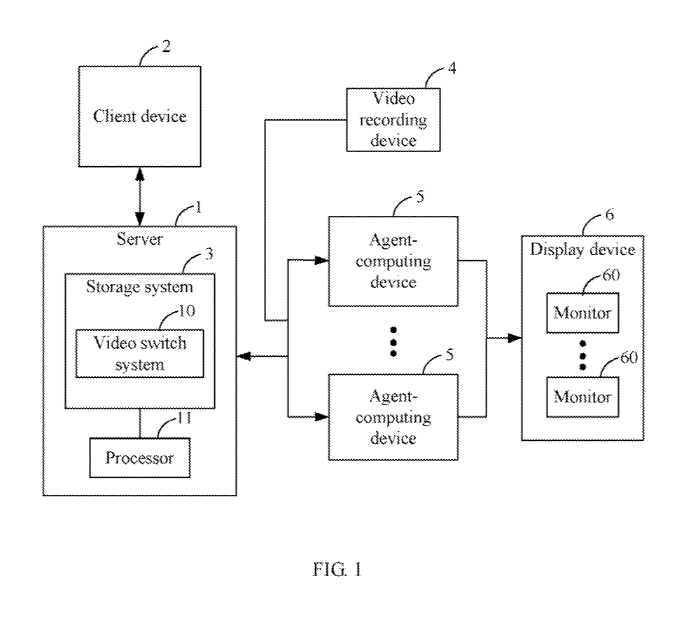

FIG. 1 is a block diagram of one embodiment of a server 1 including a video switch system 10. In the embodiment, the server 1 further includes a storage system 3 and at least one processor 11. The video switch system 10 may be in form of one or more programs stored in the storage system 3 and executed by the at least one processor 11. FIG. 1 is just one example of the server 1 that can be included with more or fewer components than shown in other embodiments, or have a different configuration of the various components.

In the embodiment, the server 1 communicates with a client device 2 through a first network, such as a local area network or a wireless network. The client device 2 may be, for example, a computer or a mobile phone. Furthermore, the server 1 communicates with at least one agent-computing device 5 through a second network, such as a wide area network or the Internet. The at least one agent-computing device 5 electronically connects to one or more video recording devices 4 positioned within monitored places that are configured to record surveillance videos of the monitored places. The monitored places may be a road, a room, a supermarket, a bank, or any other places to be monitored. The video recording devices 4 may be digital video recorders (DVR), for example.

The at least one agent-computing device 5 may further connect with a display device 6 that includes one or more monitors 60. Each of the monitors 60 can display the surveillance videos recorded in the video recording devices 4, and the surveillance video actually being displayed on the monitors 60 can be switched according to the requirements of authorized persons (surveillance staffs).

In one embodiment, the storage system 3 may be a random access memory (RAM) for temporary storage of information, and/or a read only memory (ROM) for permanent storage of information. In other embodiments, the storage system 3 may also be an external storage device, such as a hard disk, a storage card, or a data storage medium. The at least one processor 11 executes computerized operations of the server 1 and other applications, to provide functions of the server 1.

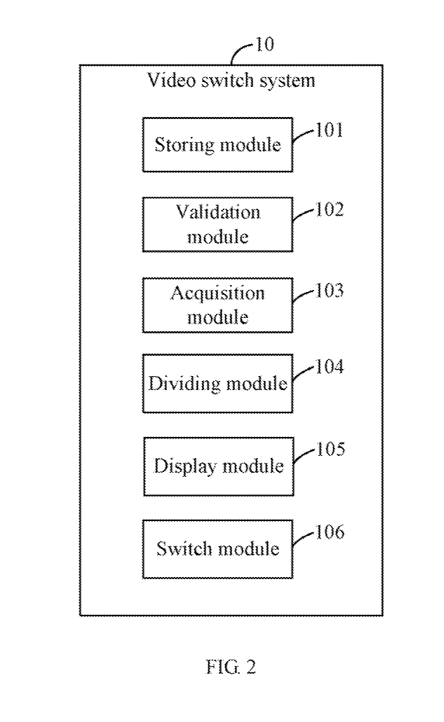

FIG. 2 is a block diagram of one embodiment of functional modules of the video switch system 10 included in the server 1 of FIG. 1. In one embodiment, the video switch system 10 may include a storing module 101, a validation module 102, an acquisition module 103, a dividing module 104, a display module 105, and a switch module 106. The modules 101-106 may comprise a plurality of functional modules each comprising one or more programs or computerized codes that can be accessed and executed by the at least one processor 11. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The storing module 101 stores an account list that includes a plurality of accounts for permitting surveillance staffs to log in the server 1 via the client device 2. Each of the accounts may include a user name and a password. The storing module 101 further stores a connection relationship between each monitor 60 and the at least one agent-computing device 5 in the storage system 3. The connection relationship shows data indicative of relationships between the monitor 60 and the agent-computing device 5, such as a No. 1 agent-computing device 5 connects to a No. 1 monitor 60, a No. 2 agent-computing device 5 connects to a No. 2 monitor 60, etc.

A surveillance staff can input an account to the client device 2 in order to log into the server 1 when the surveillance staff needs to view the surveillance videos of each of the monitored places simultaneously, such as a supermarket and a bank. The validation module 102 validates whether the input account is a valid account according to the account list in the storage system 3. If the input account matches one of the accounts in the account list, the validation module 102 determines the input account is a valid account. Otherwise, if no account in the account list is found to match the input account, the validation module 102 determines that the input account does not represent a valid account.

The acquisition module 103 acquires a user-input mode for the surveillance videos from the client device 2 when the input account is a valid account. The user-input mode includes a dividing mode, an arrangement mode, and a switch mode. Further details of each of the dividing mode, the arrangement mode, and the switch mode are defined below. The dividing mode, arrangement mode, and switch mode are set by the surveillance staff via a keyboard or a touch screen of the client device 2. The acquisition module 103 saves the dividing mode, arrangement mode, and switch mode in the storage system 3.

The dividing mode is defined as a display mode that divides display screens of each of the monitors 60 into several sub-display areas. For example, if the display device 6 includes two monitors 60 (No. 1 monitor 60 and No. 2 monitor 60), then the display screen of the No. 1 monitor 60 may be divided into nine sub-display areas each with a 3×3 matrix, and the display screen of the No. 2 monitor 60 may be divided into four sub-display areas each with a 2×2 matrix, according to the dividing mode.

The arrangement mode is defined as a display mode where each of the surveillance videos can be displayed on one sub-display area of a monitor 60. In one example, the surveillance video of the first monitored place is arranged to be displayed on a sub-display area in the first row and the first column of the No. 1 monitor 60.

The switch mode is defined as a display mode where each individual surveillance video can be switched into or out of a sub-display area of a monitor 60. In one embodiment, the switch mode includes a periodical switch mode and a manual switch mode. For example, the surveillance video of the first monitored place may be displayed first on the sub-display area in the first row and the first column of the No. 1 monitor 60. Then the surveillance video of the second monitored place can be displayed on the sub-display area in the first row and the first column of the No. 1 monitor 60 so as to displace the surveillance video of the first monitored place, and this can be done by manual operation (the manual switch mode) or by means of an automatic cycle over a period of time (the periodical switch mode).

The dividing module 104 controls the at least one agent-computing device 5 to divide the display screens of each of the monitors 60 into several sub-display areas according to the dividing mode.

The display module 105 controls the at least one agent-computing device 5 to acquire surveillance videos of the monitored places from the video recording devices 4 and to display the individual surveillance videos on particular sub-display areas of the monitors 60, according to the arrangement mode.

The switch module 106 constantly detects whether a current surveillance video displayed on a sub-display area of a monitor 60 is switched to a predetermined next surveillance video according to the overall switch mode. When the current surveillance video is replaced or switched according to the switch mode, the switch module 106 controls an agent-computing device 5 that connects to the monitor 60 to acquire the predetermined next surveillance video from the video recording devices 4 and display the next surveillance video on the sub-display area of the monitor 60.

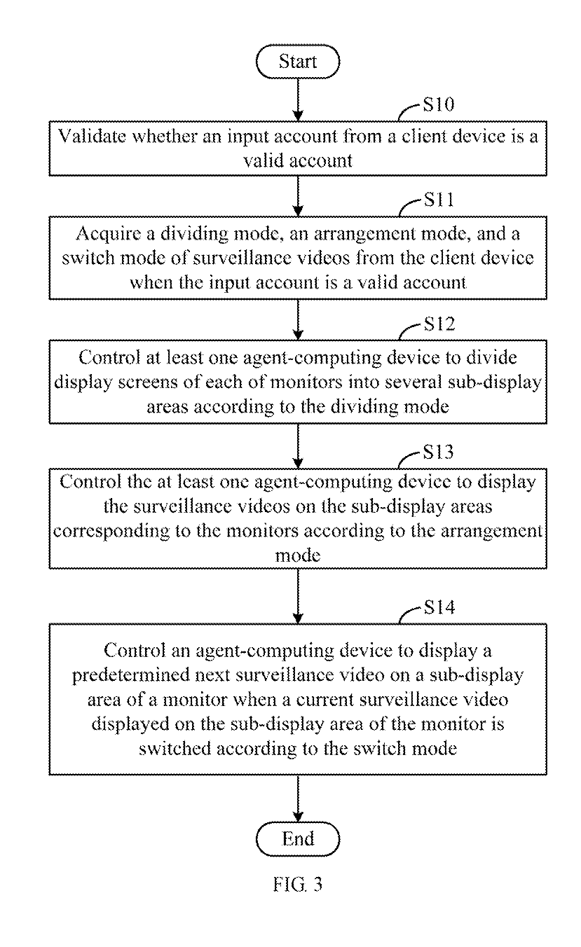

FIG. 3 is a flowchart of one embodiment of a video switch method of viewing surveillance videos implemented by the server 1 of FIG. 1. Depending on the embodiment, additional blocks may be added, others removed, and the ordering of the blocks may be changed. Before block S10, the storing module 101 stores an account list and a connection relationship between each monitor 60 and the at least one agent-computing device 5 in the storage system 3. The account list includes a plurality of accounts whereby only surveillance staffs can log in the server 1 via the client device 2 and control the display of the surveillance videos.

In block S10, the validation module 102 validates whether an input account from the client device 2 represents a valid account according to the account list in the storage system 3. If the input account matches one of the accounts in the account list, the validation module 102 determines that the input account represents a valid account. Otherwise, if no account in the account list matches the input account, the validation module 102 determines that the input account does not represent a valid account.

In block S11, the acquisition module 103 acquires a dividing mode, an arrangement mode, and a switch mode relating to the surveillance videos of the monitored places from the client device 2 when the input account is found to be a valid account. The dividing mode, arrangement mode, and switch mode are set by the surveillance staff via a keyboard or a touch screen of the client device 2. The dividing mode is defined as a display mode where the display screens of each of the monitors 60 can be divided into several sub-display areas. The arrangement mode is defined as a display mode where each of the surveillance videos can be displayed on one sub-display area of a monitor 60. The switch mode is defined as a display mode where each of the surveillance videos can be switched into or out of a particular sub-display area of a monitor 60.

In block S12, the dividing module 104 controls the at least one agent-computing device 5 to divide the display screens of each of the monitors 60 into several sub-display areas according to the dividing mode.

In block S13, the display module 105 controls the at least one agent-computing device 5 to acquire surveillance videos of the monitored places from the video recording devices 4 and to display the surveillance videos on particular sub-display areas of the monitors 60, according to the arrangement mode.

In block S14, the switch module 106 controls an agent-computing device 5 that connects to a monitor 60 to acquire a predetermined next surveillance video from the video recording devices 4 and to display the next surveillance video on a sub-display area of the monitor 60, when, according to the switch mode, a current surveillance video displayed on the sub-display area of the monitor 60 is switched to the predetermined next surveillance video.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A server that communicates with a client device and at least one agent-computing device, the at least one agent-computing device connecting to a display device that includes one or more monitors, comprising:
a storage system;
at least one processor;
one or more programs stored in the storage system and executed by the at least one processor, the one or more programs comprising:
an acquisition module that acquires a user-input mode from the client device, the user-input mode comprising a dividing mode, an arrange mode, and a switch mode;
a dividing module that controls the at least one agent-computing device to divide display screens of each of the monitors into several sub-display areas according to the dividing mode;
a display module that controls the at least one agent-computing device to display surveillance videos of monitored places from one or more video recording devices on the sub-display areas corresponding to the monitors according to the arrangement mode;
a switch module that controls an agent-computing device that connects to a monitor to display a predetermined next surveillance video on a sub-display area of the monitor to switch a current surveillance video displayed on the sub-display area of the monitor according to the switch mode.

2. The server of claim 1, further comprising a storing module stores an account list and a connection relationship between each monitor and the at least one agent-computing device in the storage system.

3. The server of claim 2, wherein the validation module determines that the input account is a valid account if the input account matches one of accounts in the account list.

4. The server of claim 1, wherein the arrange mode arranges each of the surveillance videos on a sub-display area of a monitor.

5. The server of claim 1, wherein the switch mode comprises a periodical switch mode and a manual switch mode, wherein the periodical switch mode switches the current surveillance video to the predetermined next surveillance video by means of an automatic cycle over a period of time, and wherein the manual switch mode switches the current surveillance video to the predetermined next surveillance video by manual operation.

6. A video switch method of viewing surveillance videos implemented by a server, the server communicating with a client device and at least one agent-computing device, the at least one agent-computing device connecting to a display device that includes one or more monitors, the method comprising:
(a) acquiring a user-input mode from the client device, the user-input mode comprising a dividing mode, an arrangement mode, and a switch mode;
(b) controlling the at least one agent-computing device to divide display screens of each of the monitors into several sub-display areas according to the dividing mode;
(c) controlling the at least one agent-computing device to display surveillance videos of monitored places from one or more video recording devices on the sub-display areas corresponding to the monitors according to the arrangement mode;
(d) controlling an agent-computing device that connects to a monitor to display a predetermined next surveillance video on a sub-display area of the monitor to switch a current surveillance video displayed on the sub-display area of the monitor according to the switch mode.

7. The method of claim 6, further comprising:
storing an account list and a connection relationship between each monitor and the at least one agent-computing device in the storage system.

8. The method of claim 7, wherein the block (a) further comprises:
determining the input account is a valid account if the input account matches one of accounts in the account list.

9. The method of claim 6, wherein the arrange mode arranges each of the surveillance videos on a sub-display area of a monitor.

10. The method of claim 6, wherein the switch mode comprises a periodical switch mode and a manual switch mode, wherein the periodical switch mode switches the current surveillance video to the predetermined next surveillance video by means of an automatic cycle over a period of time, and wherein the manual switch mode switches the current surveillance video to the predetermined next surveillance video by manual operation.

11. A non-transitory storage medium storing a set of instructions, the set of instructions capable of being executed by a processor of a server, causes the server to execute a video switch method of viewing surveillance videos, the server communicating with a client device and at least one agent-computing device, the at least one agent-computing device connecting to a display device that includes one or more monitors, the method comprising:
(a) acquiring a user-input mode from the client device, the user-input mode comprising a dividing mode, an arrangement mode, and a switch mode;
(b) controlling the at least one agent-computing device to divide display screens of each of the monitors into several sub-display areas according to the dividing mode;
(c) controlling the at least one agent-computing device to display surveillance videos of monitored places from one or more video recording devices on the sub-display areas corresponding to the monitors according to the arrangement mode;
(d) controlling an agent-computing device that connects to a monitor to display a predetermined next surveillance video on a sub-display area of the monitor to switch a current surveillance video displayed on the sub-display area of the monitor according to the switch mode.

12. The storage medium of claim 11, wherein the method further comprises:
storing an account list and a connection relationship between each monitor and the at least one agent-computing device in the storage system.

13. The storage medium of claim 12, wherein the block (a) further comprises:
determining the input account is a valid account if the input account matches one of accounts in the account list.

14. The storage medium of claim 11, wherein the arrange mode arranges each of the surveillance videos on a sub-display area of a monitor.

15. The storage medium of claim 11, wherein the switch mode comprises a periodical switch mode and a manual switch mode, wherein the periodical switch mode switches the current surveillance video to the predetermined next surveillance video by means of an automatic cycle over a period of time, and wherein the manual switch mode switches the current surveillance video to the predetermined next surveillance video by manual operation.
